(19) United States
(12) Patent Application Publication
(10) Pub. No.: US 2025/0129886 A1
(43) Pub. Date: Apr. 24, 2025

(54) SEALED UNDERGROUND ENERGY STORAGE CHAMBER AND SEALED UNDERGROUND ENERGY STORAGE CHAMBER SYSTEM COMPRISING THE SAME

(71) Applicants: Fucai LIU, Guangdong (CN); Min XIAO, Guangdong (CN); Haibo CUI, Guangdong (CN); Mingfu OU, Guangdong (CN)

(72) Inventors: Fucai LIU, Guangdong (CN); Min XIAO, Guangdong (CN); Haibo CUI, Guangdong (CN); Mingfu OU, Guangdong (CN)

(21) Appl. No.: 18/629,896

(22) Filed: Apr. 8, 2024

(30) Foreign Application Priority Data
Oct. 23, 2023 (CN) 202311380915.5

(51) Int. Cl. F17C 1/00

(52) U.S. Cl. CPC F17C 1/007; F17C 2203/0619; F17C 2203/0678; F17C 2209/2109; F17C 2209/225

(57) ABSTRACT

Sealed underground energy storage chamber, having a sealed underground energy storage chamber body configured within an underground rock; the sealed underground energy storage chamber body has a compound sealing layer; the compound sealing layer has a compound concrete sealing layer and a sealing liner layer arranged from outside to inside; the compound concrete sealing layer at least has one casted ultra-high-performance concrete layer; the sealing liner layer is attached to an inner surface of the casted ultra-high-performance concrete layer. A system containing at least two of the sealed underground energy storage chambers are also provided.

### TECHNICAL FIELD

The present invention relates to the technical field of energy storage, and in particular, to a sealed underground energy storage chamber and a sealed underground energy storage chamber system comprising the same.

### BACKGROUND ART

Energy is the driving force for the development of human society. In the evolution of human society, with the continuous progress of productivity and the use of modern high technologies, the demand for energy is also increasing. Yet, human society is threatened by energy crises and energy exhaustion due to excessive exploitation, and the environment of the earth is further worsened by pollution caused by the increasing use of dirty energies. These problems have aroused people's attention since a long time ago. The development of new environment-friendly energies becomes important in applied science, and the method of energy storage is also people's main focus of concern.

Air, hydrogen, and natural gas can be used as an energy storage medium. Compressed gas energy storage is a means for electrical power energy storage having advantages such as large capacity, long storage period, cost-efficiency, and a large number of charge-discharge cycles, so it is a practical way to help achieve deep de-carbonization in different fields such as energy, transportation, and petrochemistry. However, the storage of compressed gases is technologically challenging, especially in large quantities. At present, conventional compressed gas storage can be mainly divided into overground storage and underground storage. Overground storage mainly involves small-scale steel tank storage, disadvantageous in limited capacity, high cost, and high safety risk. An underground storage tank comprises a concrete liner layer and a steel plate sealing layer, but with greater diameter of the storage tank, a thicker wall for bearing pressure is required, thereby increasing the difficulties and costs of manufacturing and welding the steel plates; further, there is a risk of explosion when the steel plate sealing layer fails to perform its proper functions.

### DISCLOSURE OF THE INVENTION

The present invention is intended to overcome at least one defect of the prior arts, and it is an object of the present invention to provide a sealed underground energy storage chamber for solving the problems of excessive thickness and poor airtightness of the sealing structure layer in a prior art underground energy storage chamber.

The present invention adopts the following technical solutions:

A sealed underground energy storage chamber, comprising a sealed underground energy storage chamber body; the sealed underground energy storage chamber body has a compound sealing layer; the compound sealing layer comprises, sequentially along a radial direction from a perimeter of the sealed underground energy storage chamber body towards a central axis of the sealed underground energy storage chamber body, a compound concrete sealing layer and a sealing liner layer; the compound concrete sealing layer at least comprises one casted ultra-high-performance concrete layer; the sealing liner layer is attached to an inner surface of the casted ultra-high-performance concrete layer; a thickness of the casted ultra-high-performance concrete layer is 40-80 mm, a compressive strength of the casted ultra-high-performance concrete layer is greater than 150 Mpa, a gas permeability of the casted ultra-high-performance concrete layer is 1×10⁻¹⁸ m² to 5×10⁻¹⁹ m², and an initial cracking strain of the casted ultra-high-performance concrete layer is greater than 1000με.

According to the present invention, ultra-high-performance concrete of said casted ultra-high-performance concrete layer is formed by compaction of raw materials such as cement, mineral admixtures, fine aggregates, additives, high-strength fine steel fibers or organic synthetic fibers, and water, and also being subject to thermal activation. Compared with the commonly used steel plate materials, said ultra-high-performance concrete has advantageous properties such as high compression resistance, high tensile resistance, high durability, high tenacity, high explosion resistance, high impact resistance, and low gas permeability. Since the gas permeability of the ultra-high-performance concrete is much smaller than that of common concrete, the casted ultra-high-performance concrete layer can also provide good sealing performance. Use of the compound concrete sealing layer containing the casted ultra-high-performance concrete layer in the compound sealing layer of the sealed underground energy storage chamber would solve the problems such as insufficient airtightness and insufficient structural strength in prior art compressed gas energy storage, and can save the space occupied by the compound concrete sealing layer due to lesser materials being used, therefore, use of the casted ultra-high-performance concrete layer in the compound concrete sealing layer in combination with at least one layer of another concrete material layer can provide high structural strength for the sealed underground energy storage chamber, and also provide a larger space for compressed gas energy storage. Besides, use of the sealing liner layer at the inner surface of the casted ultra-high-performance concrete layer can provide a first airtight protection layer for gas stored in the sealed underground energy storage chamber, such that a compound sealing effect is achieved by the sealing liner layer in combination with the ultra-high-performance concrete layer disposed on an outer side of the sealing liner layer. The sealing liner layer also has other effects such as preventing loosening and falling of the underground rock, enhancing the stability of the underground rock surrounding the sealed underground energy storage chamber, and preventing entry of excessive underground water into the sealed underground energy storage chamber, thus greatly improving the safety of gas storage.

Based on the above parameters described above for the thickness, compressive strength, gas permeability, and initial cracking strain of the casted ultra-high-performance concrete layer, the casted ultra-high-performance concrete layer has good airtightness and structural strength, and further reduces the space occupied by the compound concrete sealing layer, so that a larger gas storage space can be provided for the sealed underground energy storage chamber under the same construction space as compared to the prior art.

Further, a plurality of first fasteners are provided between the compound concrete sealing layer and the underground rock; preferably, the first fasteners are anchoring members which are in rod shape; two ends of each of the anchoring members are inserted into the underground rock and the compound concrete sealing layer respectively.

Use of the anchoring members enhances the bonding strength between the compound concrete sealing layer and the underground rock, so as to significantly reduce the risk of disengagement of the compound concrete sealing layer, thereby enhancing the structural strength of the compound sealing layer.

Further, a plurality of second fasteners are provided between the sealing liner layer and the casted ultra-high-performance concrete layer; preferably, the second fasteners are V-shaped anchoring members; the V-shaped insert passes through the sealing liner layer and then being embedded into the casted ultra-high-performance concrete layer, such that the sealing liner layer is attached to the inner surface of the casted ultra-high-performance concrete layer.

By using the V-shaped anchoring members, the sealing liner layer is tightly attached to the inner surface of the casted ultra-high-performance concrete layer to enhance the bonding strength between the two and reduce the risk of disengagement of the sealing liner layer.

Further, each of the anchoring members has a diameter of 20-30 mm; and/or each of the anchoring members has a length of 920-1520 mm; and/or a length of a portion of each of the anchoring members inserted into the underground rock is 600-1200 mm; and/or the anchoring members are spaced apart from one another by an interval of 1000-2000 mm.

Based on the above described diameter, length, length of the portion inserted into the underground rock, and the interval which the anchoring members are spaced apart from one another, the connection strength is good between the anchoring members and the underground rock. On the other hand, the bonding strength is good between the compound concrete sealing layer and the underground rock through the anchoring members, thereby greatly reducing the risk of disengagement of the compound concrete sealing layer.

Further, the compound concrete sealing layer further comprises a self-stressing sprayed concrete layer; the self-stressing sprayed concrete layer and the casted ultra-high-performance concrete layer are sequentially laminated layers laminated along a radial direction from a perimeter of the sealed underground energy storage chamber body towards a central axis of the sealed underground energy storage chamber body.

According to the present invention, lamination of the self-stressing sprayed concrete layer and the casted ultra-high-performance concrete layer can on one hand increase the structural strength of the compound concrete sealing layer, and on the other hand reduce the amount of material used and a thickness of the compound sealing layer so as to provide a larger storage space. Further, due to the strong airtightness effect of the compound concrete sealing layer, gas is prevented from leakage and the sealed underground energy storage chamber is also prevented from damage in case of failure of the sealing liner layer or accidental overpressure of the sealed underground energy storage chamber.

Preferably, a thickness of the self-stressing sprayed concrete layer is 80-400 mm; and/or self-stressing of the self-stressing sprayed concrete layer is not less than 1 Mpa; and/or a compressive strength of the self-stressing sprayed concrete layer is not less than 40 Mpa.

Based on the parameters of the thickness, self-stressing, and compressive strength of the self-stressing sprayed concrete layer, the self-stressing sprayed concrete layer has a good structural strength, and material consumption is reduced, thus reducing the thickness of the compound concrete sealing layer and also ensuring high safety coefficient of the sealed underground energy storage chamber and providing a larger gas storage space.

According to another embodiment, the self-stressing sprayed concrete layer is formed as an ultra-high-performance self-stressing sprayed concrete layer; preferably, a thickness of the ultra-high-performance self-stressing sprayed concrete layer is 80-120 mm.

Use of ultra-high-performance self-stressing sprayed concrete layer can reduce material consumption, thus reducing the overall thickness of the compound concrete sealing layer. Also, since ultra-high-performance concrete has good airtightness and high structural strength, the sealing effect and safety performance of the compound sealing layer of the sealed underground energy storage chamber are enhanced.

Further, a first steel reinforcing mesh layer is provided inside the self-stressing sprayed concrete layer.

The first steel reinforcing mesh layer provides an additional supporting structure inside the self-stressing sprayed concrete layer, so as to enhance the structural strength of the self-stressing sprayed concrete layer.

Preferably, a volume of the first steel reinforcing mesh layer being used is not less than 1.5% of a volume of the self-stressing sprayed concrete layer; and/or the first steel reinforcing mesh layer comprises a plurality of first steel reinforcement bars, where a diameter of each of the first steel reinforcement bars is 8-12 mm; and/or the first steel reinforcing mesh layer is formed as a first grid, where each side length of each grid unit of the first grid is 100-300 mm; and/or a thickness of a protective layer of the first steel reinforcing mesh layer is 30-50 mm, wherein the protective layer of the first steel reinforcing mesh layer is a portion of the self-stressing sprayed concrete layer extending from the first steel reinforcing mesh layer to an outer side surface of the self-stressing sprayed concrete layer.

Based on the volume of the first steel reinforcing mesh layer, spatial distance and diameter of the first steel reinforcement bars of the first steel reinforcing mesh layer, and thickness of the protective layer of the first reinforcing mesh layer as described above, the first steel reinforcing mesh layer enhances the supporting strength against the self-stressing sprayed concrete layer.

Further, a second steel reinforcing mesh layer is provided inside the casted ultra-high-performance concrete layer.

The second steel reinforcing mesh layer provides an additional supporting structure inside the casted ultra-high-performance concrete layer, so that the structural strength of the casted ultra-high-performance concrete layer, and the overall performance of the compound concrete sealing layer can be enhanced, so that the compound sealing layer of the sealed underground energy storage chamber is more safe and reliable.

Preferably, a volume of the second steel reinforcing mesh layer being used is not less than 1.5% of a volume of the casted ultra-high-performance concrete layer; and/or the second steel reinforcing mesh layer comprises a plurality of second steel reinforcement bars whereas a diameter of each of the second steel reinforcement bars is 4-10 mm; and/or the second steel reinforcing mesh layer is formed as a second grid, where each side length of each grid unit of the second grid is 100-300 mm; and/or a thickness of a protective layer of the second steel reinforcing mesh layer is 25-40 mm, wherein the protective layer of the second steel reinforcing mesh layer is a portion of the casted ultra-high-performance concrete layer extending from the second steel reinforcing mesh layer to an outer side surface of the casted ultra-high-performance concrete layer.

Based on the volume of the second steel reinforcing mesh layer, spatial distance and diameter of the second steel reinforcement bars of the second steel reinforcing mesh layer, and thickness of the protective layer of the second reinforcing mesh layer as described above, the second steel reinforcing mesh layer enhances the supporting strength against the casted ultra-high-performance concrete layer.

Further, the sealing liner layer is formed as a high-density polyethylene layer.

The high-density polyethylene material has good airtightness, and can therefore improve the sealing performance against gas in the sealed underground energy storage chamber. The high-density polyethylene material also has an extremely low water absorption capacity, and can therefore prevent water in the underground rock from permeating into the sealed underground energy storage chamber. Furthermore, the durability of the sealing liner layer is improved due to the high acid/base corrosion resistance of the high-density polyethylene material, thereby reducing the maintenance and replacement costs.

Preferably, a thickness of the high-density polyethylene layer is 4-6 mm; and/or a yield strength of the high-density polyethylene layer is not less than 30 Mpa; and/or a maximum tensile strength of the high-density polyethylene layer is not less than 50 Mpa; and/or a thermal resistance range of the high-density polyethylene layer is from −50° C. to 90° C.

Based on the thickness, the yield strength, the maximum tensile strength, and the thermal resistance range of the high-density polyethylene layer as described above, the sealing liner layer can meet the storage requirements for more kinds of gases, and can achieve better sealing effect and safety.

Further, a shearing resistance achieved via the V-shaped anchoring members between the high-density polyethylene layer and the inner surface of the compound concrete sealing layer 10 is not less than 20 Mpa, a bonding strength of anchoring cross-sections of the V-shaped anchoring members is not less than 10 Mpa, and an anchoring depth of each of the V-shaped anchoring members into the compound concrete sealing layer is not less than 20 mm.

Further, the sealed underground energy storage chamber body comprises a hollow cylindrical portion and a hemispherical end portion at each of two ends of the hollow cylindrical portion; the hollow cylindrical portion and each hemispherical end portion are provided with the aforementioned compound sealing layer.

Optionally, the hollow cylindrical portion has an inner diameter of 8-15 m, preferably 8 m, and a length of 80-150 m, preferably 80 m.

It is a further object of the present invention to provide a sealed underground energy storage chamber system, comprising at least two sealed underground energy storage chambers; said at least two sealed underground energy storage chambers are arranged parallel to each other and are mutually spaced apart from each other along radial directions of cross sections of said at least two sealed underground energy storage chambers; a connecting member is provided between sealed underground energy storage chamber bodies of every two adjacent sealed underground energy storage chambers to connect the two adjacent sealed underground energy storage chambers.

Optionally, a distance between said every two adjacent sealed underground energy storage chambers is 50-80 m.

Due to the distance mentioned between every two adjacent sealed underground energy storage chambers, gas storage space can be fully utilized while ensuring the safety of the sealed underground energy storage chambers,

Compared with the prior art, the present invention has the following beneficial effects:

1) Compared with the existing overground steel tank, the sealed underground energy storage chamber of the present invention possesses a greatly increased capacity. The sealed underground energy storage chamber features a greatly increased storage capacity for compressed gases, reduced gas loss, and a wide scope of applications.

2) The sealed underground energy storage chamber of the present invention also has a significantly reduced safety risk due to the improved gas leakage prevention performance for storing inflammable and explosive gases such as compressed hydrogen, natural gas, and the like, thus possessing a greatly reduced safety risk index and mitigated consequences and impacts in case of accidents.

3) The sealed underground energy storage chamber of the present invention further features reduced construction difficulties, a lower amount of material consumption, and a reduced cost. By replacing the steel plates with ultra-high-performance concrete, the construction difficulty is reduced and the thickness of the concrete liner layer can be reduced, thus saving the materials and energy.

### BRIEF DESCRIPTION OF DRAWINGS

FIG. 1 is a structural view of a sealed underground energy storage chamber according to the present invention.

FIG. 2 is a cross-sectional view of the sealed underground energy storage chamber according to an embodiment of the present invention.

FIG. 3 is an enlarged view of portion B in FIG. 2.

FIG. 4 is a cross-sectional view of the sealed underground energy storage chamber according to another embodiment of the present invention.

FIG. 5 is a structural view of a sealing liner layer according to an embodiment of the present invention.

FIG. 6 is a structural view of a second fastener according to an embodiment of the present invention.

FIG. 7 is a structural view of a sealed underground energy storage chamber system according to the present invention.

FIG. 8 is a cross-sectional view of a first steel reinforcing mesh layer according to the present invention.

FIG. 9 is a cross-sectional view of a second steel reinforcing mesh layer according to the present invention.

FIG. 10 is a self-stressing sprayed concrete layer in the structure shown in FIG. 3.

FIG. 11 is a casted ultra-high-performance concrete layer in the structure shown in FIG. 3.

FIG. 12 is a layout of a first steel reinforcing mesh layer according to the present invention.

FIG. 13 is a layout of a second steel reinforcing mesh layer according to the present invention.

Reference numerals: underground rock 1, sealed underground energy storage chamber body 2, cylindrical portion 21, hemispherical end portion 22, compound concrete sealing layer 10, self-stressing sprayed concrete layer 100, first steel reinforcing mesh layer 110, first steel reinforcement bar 111, grid unit of the first grid 112, protective layer of the first steel reinforcing mesh layer 110, casted ultra-high-performance concrete layer 200, second steel reinforcing mesh layer 210, second steel reinforcement bar 211, grid unit of the second grid 212, protective layer of the second steel reinforcing mesh layer 220 sealing liner layer 300, first fastener 400, second fastener 500, supporting part 510, V-shaped insert 520, connecting member 600, and ultra-high-performance self-stressing sprayed concrete layer 700.

### BEST MODE FOR CARRYING OUT THE INVENTION

The drawings of the present invention are intended for illustrative purpose only, and should not be construed as limiting the present invention. For the purpose of better illustrating the examples below, certain components of the drawings may be omitted, enlarged or reduced; the drawings may not represent the size of an actual product. It will be appreciated by those skilled in the art that certain well-known structures may be omitted in the drawings and may not be described in the specification.

### Example 1

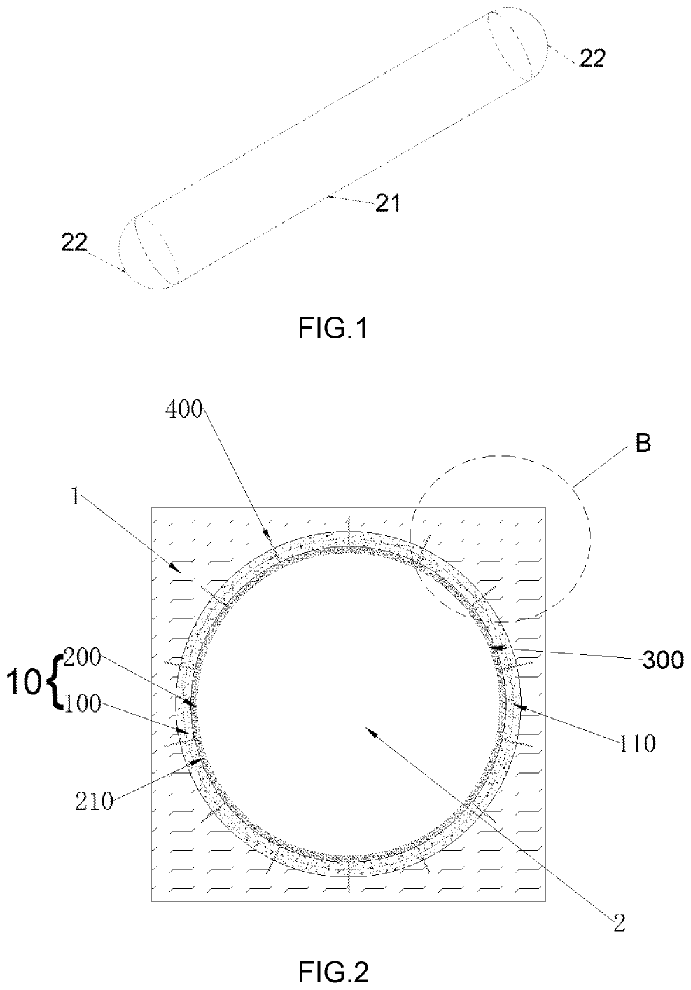

As shown in FIGS. 1-3, in this example, a sealed underground energy storage chamber is provided, comprising a sealed underground energy storage chamber body 2. The sealed underground energy storage chamber body 2 has a compound sealing layer comprising, sequentially along a radial direction from a perimeter of the sealed underground energy storage chamber body 2 towards a central axis of the sealed underground energy storage chamber body 2, a compound concrete sealing layer 10 and a sealing liner layer 300. The compound concrete sealing layer 10 at least comprises one casted ultra-high-performance concrete (UHPC) layer 200. The sealing liner layer 300 is attached to an inner surface of the casted ultra-high-performance concrete layer 200. According to a specific implementation, in order to provide a larger energy storage space and improve the structural strength, the sealed underground energy storage chamber body 2 is a hollow cylinder. In some embodiments, the hollow cylinder has an inner diameter of 8-15 m, preferably 8 m, and a length of 80-150 m, preferably 80 m. The compound concrete sealing layer 10 is connected to the underground rock 1 via a plurality of first fasteners 400 to enhance the strength of connection between the two. The first fasteners 400 are preferably anchoring members. During construction, a portion of each of the anchoring members is inserted into the underground rock 1, and then the compound concrete sealing layer 10 is constructed in the underground rock 1. In a preferred embodiment, each of the anchoring members being inserted into a surface of the underground rock 1 is a rod with a diameter of 20-30 mm and a length of 920-1520 mm. A length of the portion of each of the anchoring members inserted into the underground rock 1 is 600-1200 mm, and the anchoring members are spaced apart from one another by an interval of 1000-2000 mm, such that the bonding force between the compound concrete sealing layer 10 and the underground rock 1 can be maximally improved.

In a specific implementation, the compound concrete sealing layer 10 is formed by at least one layer of said casted ultra-high-performance concrete layer 200 and at least one layer of another concrete material layer through lamination.

Ultra-high-performance concrete (UHPC) of said casted ultra-high-performance concrete layer 200 is formed by compaction of raw materials such as cement, mineral admixtures, fine aggregates, additives, high-strength fine steel fibers or organic synthetic fibers, and water, and also being subject to thermal activation. Compared with the commonly used steel plate materials, said ultra-high-performance concrete has advantageous properties such as high compression resistance, high tensile resistance, high durability, high tenacity, high explosion resistance, high impact resistance, and low gas permeability. Since the gas permeability of the ultra-high-performance concrete is much smaller than that of common concrete, the casted ultra-high-performance concrete layer 200 can also provide good sealing performance. Use of the compound concrete sealing layer 10 containing the casted ultra-high-performance concrete layer 200 in the compound sealing layer of the sealed underground energy storage chamber would solve the problems such as insufficient airtightness and insufficient structural strength in prior art compressed gas energy storage, and can save the space occupied by the compound concrete sealing layer 10 due to lesser materials being used, therefore, use of the casted ultra-high-performance concrete layer 200 in the compound concrete sealing layer 10 in combination with said at least one layer of another concrete material layer can provide high structural strength for the sealed underground energy storage chamber, and also provide a larger space for compressed gas energy storage. In a specific implementation, in order to provide the casted ultra-high-performance concrete layer 200 with good airtightness and good structural strength, a thickness of the casted ultra-high-performance concrete layer 200 is 40-80 mm, a compressive strength of the casted ultra-high-performance concrete layer 200 is greater than 150 Mpa, and a gas permeability of the casted ultra-high-performance concrete layer 200 is 1×10⁻¹⁸ m² to 5×10⁻¹⁹ m². Additionally/alternatively, an initial cracking strain of the casted ultra-high-performance concrete layer 200 is greater than 1000με (microstrain unit). Based on the above parameters, the casted ultra-high-performance concrete layer 200 occupies a small space in the compound sealing layer, but provides high structural strength. As such, a larger gas storage space can be provided within a certain limited construction space, and a higher safety coefficient and airtightness can be guaranteed.

In addition, the sealing liner layer 300 can provide a first airtight protection layer for gas stored in the sealed underground energy storage chamber, such that a compound sealing effect is achieved by the sealing liner layer 300 in combination with the ultra-high-performance concrete layer 200 disposed on an outer side of the sealing liner layer 300. The sealing liner layer 300 also has other effects such as preventing loosening and falling of the underground rock 1, enhancing the stability of the underground rock 1 surrounding the sealed underground energy storage chamber, and preventing entry of excessive underground water into the sealed underground energy storage chamber, thus greatly improving the safety of gas storage.

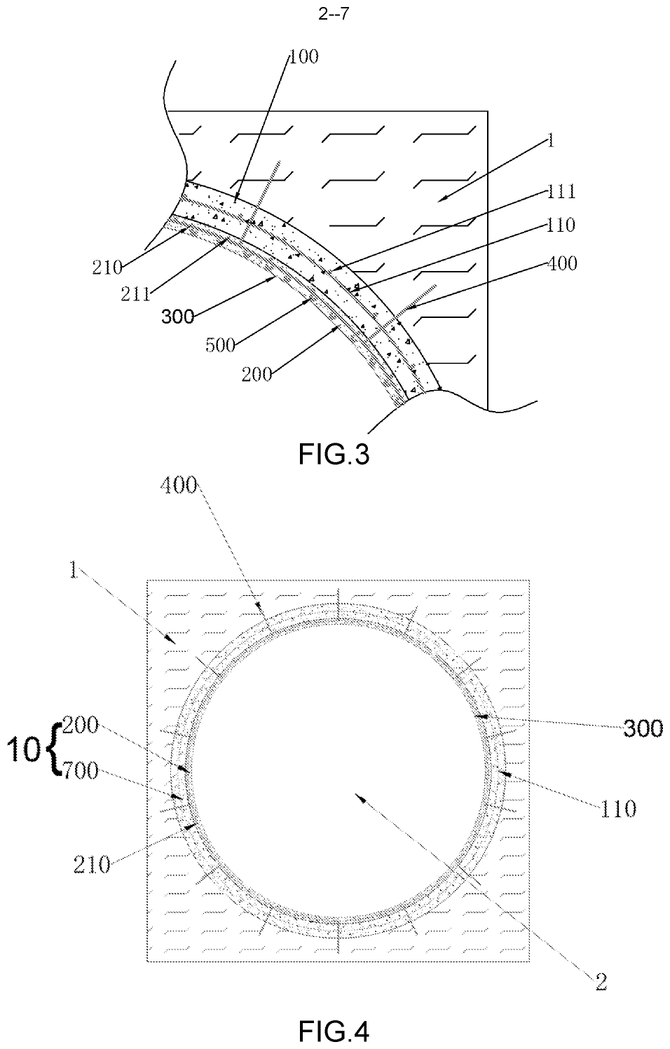

As shown in FIGS. 2-3, the compound concrete sealing layer 10 further comprises at least one self-stressing sprayed concrete layer 100. Said at least one self-stressing sprayed concrete layer 100 and the casted ultra-high-performance concrete layer 200 are sequentially laminated layers laminated along a radial direction from a perimeter of the sealed underground energy storage chamber body 2 towards a central axis of the sealed underground energy storage chamber body 2, and the sealing liner layer 300 is attached to an inner surface of the casted ultra-high-performance concrete layer 200. In a specific implementation, in order to reduce the overall structural thickness of the sealing layer structure and provide a larger gas storage space for the sealed underground energy storage chamber, the compound concrete sealing layer 10 is formed by one self-stressing sprayed concrete layer 100 and one casted ultra-high-performance concrete layer 200 sequentially laminated along the radial direction from the perimeter of the sealed underground energy storage chamber body 2 towards the central axis of the sealed underground energy storage chamber body 2. In practice, in order to ensure that the bonding strength between said one self-stressing sprayed concrete layer 100 and said one casted ultra-high-performance concrete layer 200 is enough to meet the structural strength requirement and the airtightness requirement of the sealed underground energy storage chamber, a thickness of the self-stressing sprayed concrete layer 100 is 80-400 mm. When the self-stressing sprayed concrete layer comprises only common concrete, a thickness of the self-stressing sprayed concrete layer 100 is required to be 200-400 mm to meet the requirement for the structural strength. In addition, self-stressing of the self-stressing sprayed concrete layer 100 is not less than 1 Mpa, and a compressive strength of the self-stressing sprayed concrete layer 100 is not less than 40 Mpa.

As shown in FIG. 4, in a preferred implementation, in order to further reduce the thickness of the compound concrete sealing layer 10, the self-stressing sprayed concrete layer 100 is formed as an ultra-high-performance self-stressing sprayed concrete layer 700. In this case, the compound concrete sealing layer 10 is formed by one ultra-high-performance self-stressing sprayed concrete layer 700 and one casted ultra-high-performance concrete layer 200 sequentially laminated along the radial direction from the perimeter of the sealed underground energy storage chamber body 2 towards the central axis of the sealed underground energy storage chamber body 2. In a specific implementation, a thickness of the ultra-high-performance self-stressing sprayed concrete layer 700 is 80-120 mm, such that the thickness of the compound concrete sealing layer 10 can be greatly reduced. Besides, due to the compound effect of the two ultra-high-performance concrete layers 700 and 200, the sealing effect and the safety performance of the sealing layer structure of the sealed underground energy storage chamber can be further enhanced.

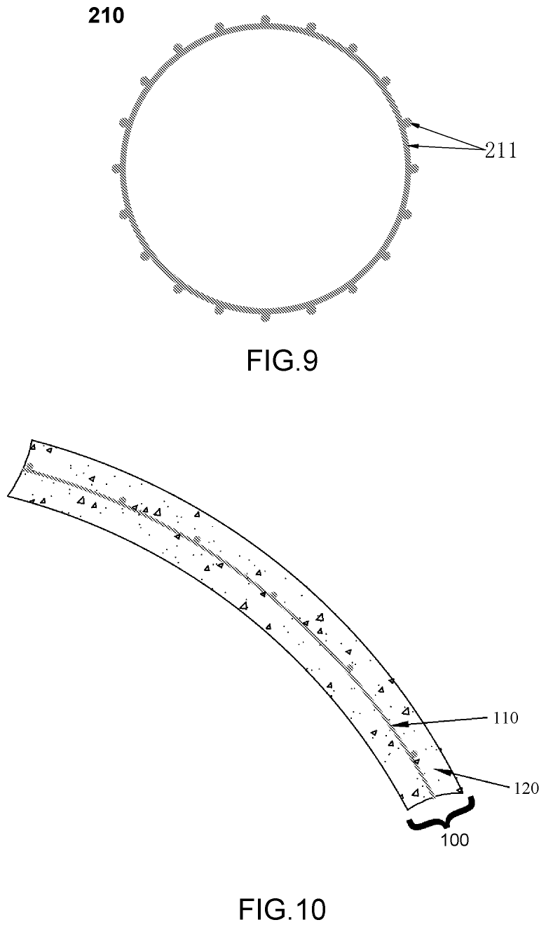

As shown in FIGS. 3, 8, 10 and 12, a first steel reinforcing mesh layer 110 is provided inside the self-stressing sprayed concrete layer 100. In a specific implementation, in order to provide better structural strength, a volume of the first steel reinforcing mesh layer 110 being used is not less than 1.5% of a volume of the self-stressing sprayed concrete layer 100. In practice, as shown in FIGS. 8 and 12, the first steel reinforcing mesh layer 110 comprises a plurality of first steel reinforcement bars 111. The plurality of first steel reinforcement bars 111 are divided into two groups each containing a plural number of said first steel reinforcement bars 11, where the first steel reinforcement bars 111 of a first of the two groups of the first steel reinforcement bars 111 are circumferentially arranged in a cross sectional area of the self-stressing sprayed concrete layer 100, and are spaced apart from one another, and where the first steel reinforcement bars 11 of a second of the two groups of the first steel reinforcement bars 111 extend longitudinally in the self-stressing sprayed concrete layer 100 along a longitudinal direction of the self-stressing sprayed concrete layer 100 perpendicular to a cross section of the self-stressing sprayed concrete layer 100, and are also spaced part from one another. The two groups of the first steel reinforcement bars 111 arranged according to two different directions form the first steel reinforcing mesh layer 110 on which a dense first grid is formed where each grid unit 112 is a square. In a preferred embodiment, each side length of each grid unit 112 of the first grid is 100-300 mm, that is to say, opposite first steel reinforcement bars 111 in each grid unit are spaced apart by 100-300 mm. In addition, in a specific implementation, a diameter of each of the first steel reinforcement bars 111 is 8-12 mm, and a thickness of a protective layer 120 of the first steel reinforcing mesh layer 110 is 30-50 mm, such that the self-stressing sprayed concrete layer 100 possesses higher structural strength, and the thickness and material consumption thereof are reduced. In practice, as shown in FIG. 10, the protective layer 120 of the first steel reinforcing mesh layer 110 is a portion of the self-stressing sprayed concrete layer 100; more particularly, the protective layer 120 refers to the portion of the self-stressing sprayed concrete layer 100 extending from the first steel reinforcing mesh layer 110 to an outer side surface of the self-stressing sprayed concrete layer 100.

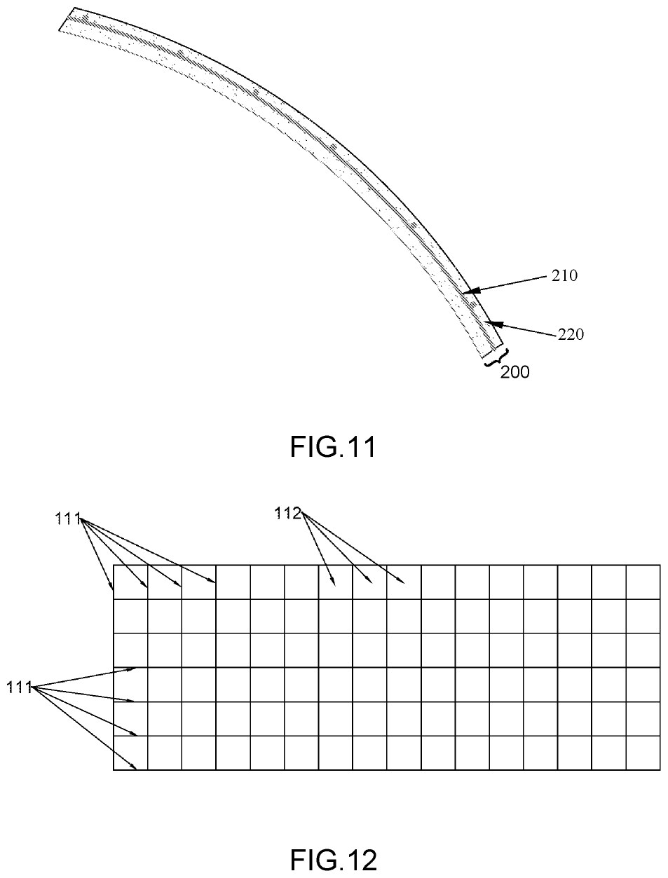

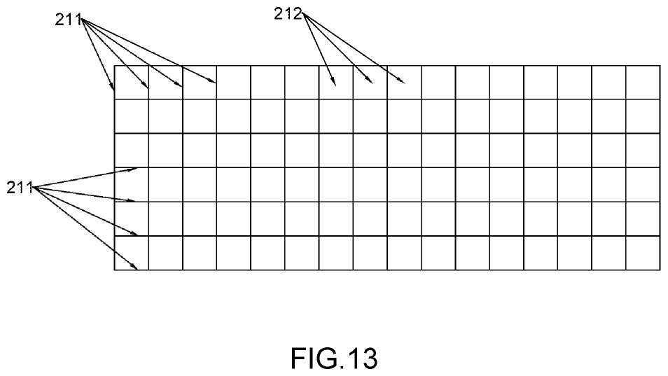

As shown in FIGS. 3, 9, 11, 13, a second steel reinforcing mesh layer 210 is provided inside the casted ultra-high-performance concrete layer 200. In a specific implementation, in order to ensure a certain structural strength, a volume of the second steel reinforcing mesh layer 210 being used is not less than 1.5% of a volume of the casted ultra-high-performance concrete layer 200. In practice, as shown in FIGS. 11 and 13, the second steel reinforcing mesh layer 210 comprises a plurality of second steel reinforcement bars 211. The plurality of second steel reinforcement bars 211 are divided into two groups each containing a plural number of said second steel reinforcement bars 211, where the second steel reinforcement bars 211 of a first of the two groups of the second steel reinforcement bars 211 are circumferentially arranged in a cross sectional area of the casted ultra-high-performance concrete layer 200, and are spaced apart from one another, and where the second steel reinforcement bars 211 of a second of the two groups of the second steel reinforcement bars 211 extend longitudinally in the casted ultra-high-performance concrete layer 200 along a longitudinal direction of the casted ultra-high-performance concrete layer 200 perpendicular to a cross section of the casted ultra-high-performance concrete layer 200, and are also spaced apart from one another. The two groups of the second steel reinforcement bars 211 arranged according to two different directions form the second steel reinforcing mesh layer 210 on which a dense second grid is formed where each grid unit is a square. In a preferred embodiment, each side length of each grid unit 212 of the second grid is 100-300 mm, that is to say, opposite second steel reinforcement bars 211 in each grid unit are spaced apart by 100-300 mm. In addition, in a specific implementation, a diameter of each of the second steel reinforcement bars 211 is 4-10 mm, and a thickness of a protective layer 220 of the second steel reinforcing mesh layer 210 is 25-40 mm. In a specific using process, the second steel reinforcing mesh layer 210 provides an additional supporting structure inside the casted ultra-high-performance concrete layer 200, such that the casted ultra-high-performance concrete layer 200 maintains a high level of structural strength in spite of smaller thickness, so as to meet the requirement of the sealed underground energy storage chamber in respect of safety performance. In practice, as shown in FIG. 11, the protective layer 220 of the second steel reinforcing mesh layer 210 is a portion of the casted ultra-high-performance concrete layer 200; more particularly, the protective layer 220 refers to the portion of the casted ultra-high-performance concrete layer 200 extending from the second steel reinforcing mesh layer 210 to an outer side surface of the casted ultra-high-performance concrete layer 200.

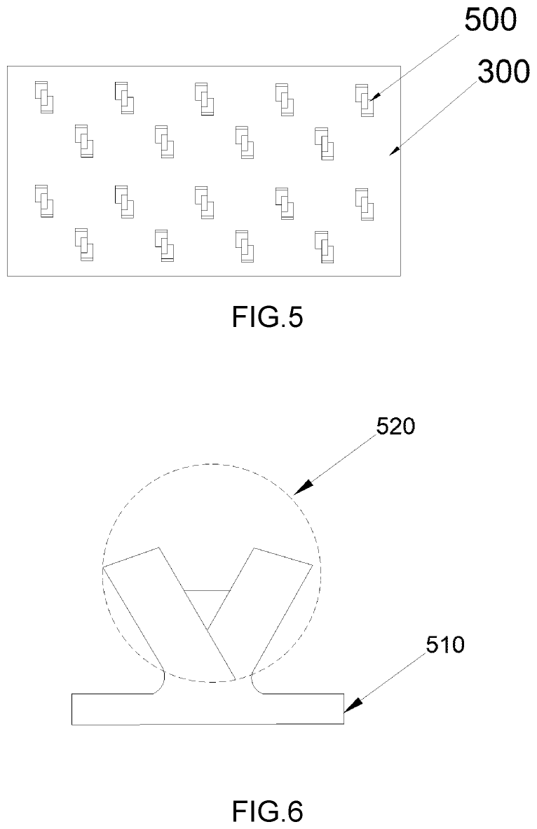

As shown in FIG. 3, a plurality of second fasteners 500 are further disposed between the sealing liner layer 300 and the casted ultra-high-performance concrete layer 200. In a specific implementation, with reference to FIGS. 5-6, the second fasteners 500 are V-shaped anchoring members each having a supporting part 510 and a V-shaped insert 520 connected with each other. The supporting part 510 is supported against an inner surface of the sealing liner layer 300, and the V-shaped insert 520 passes through the sealing liner layer 300 and then being embedded into the casted ultra-high-performance concrete layer 200, such that the sealing liner layer 300 is attached to the inner surface of the casted ultra-high-performance concrete layer 200.

In a preferred embodiment, the sealing liner layer 300 is formed as a high-density polyethylene layer. In application, the high-density polyethylene material has good airtightness, and can therefore improve the sealing performance against gas in the sealed underground energy storage chamber. The high-density polyethylene material also has an extremely low water absorption capacity, and can therefore prevent water in the underground rock 1 from permeating into the sealed underground energy storage chamber. Furthermore, the durability of the sealing liner layer 300 is improved due to the high acid/base corrosion resistance of the high-density polyethylene material, thereby reducing the maintenance and replacement costs. In an implementation, a thickness of the high-density polyethylene layer is 4-6 mm, a yield strength of the high-density polyethylene layer is not less than 30 Mpa, a maximum tensile strength of the high-density polyethylene layer is not less than 50 Mpa, and a thermal resistance range of the high-density polyethylene layer is from −50° C. to 90° C. Based on the above parameters, the sealing liner layer 300 and the compound concrete sealing layer 10 formed by combining the casted ultra-high-performance concrete layer 200 and the self-stressing sprayed concrete layer 100 achieve a good synergic effect, such that the compound sealing layer of the present invention has excellent performances in airtightness and structural strength, and occupies a smaller space, therefore being beneficial to providing a larger gas storage space in the sealed underground energy storage chamber.

In addition, in a specific implementation, in order to improve the bonding strength of the high-density polyethylene layer to the inner surface of the casted ultra-high-performance concrete layer 200, a shearing resistance achieved via the V-shaped anchoring members between the high-density polyethylene layer and the inner surface of the compound concrete sealing layer 10 is not less than 20 Mpa, a bonding strength of anchoring cross-sections of the V-shaped anchoring members is not less than 10 Mpa, and an anchoring depth of each of the V-shaped anchoring members into the compound concrete sealing layer 10 is not less than 20 mm.

As shown in FIG. 1, the sealed underground energy storage chamber body 2 comprises a hollow cylindrical portion 21 and a hemispherical end portion 22 at each of two ends of the hollow cylindrical portion 21; the hollow cylindrical portion 21 and each hemispherical end portion 22 are provided with the aforementioned compound sealing layer. During use, the hemispherical end portion 22 can improve pressure homogeneity within the sealed underground energy storage chamber, and reduce pressure heterogeneity which may otherwise present at flat surfaces or corners in case end surfaces of the sealed underground energy storage chamber has such flat surfaces or corners. In addition, in a specific implementation, a first flange is provided between each hemispherical end portion 22 and the hollow cylindrical portion 21 adjacent thereto for installation and fixation, so as to improve the sealing effect and pressure homogeneity of the sealed underground energy storage chamber.

### Example 2

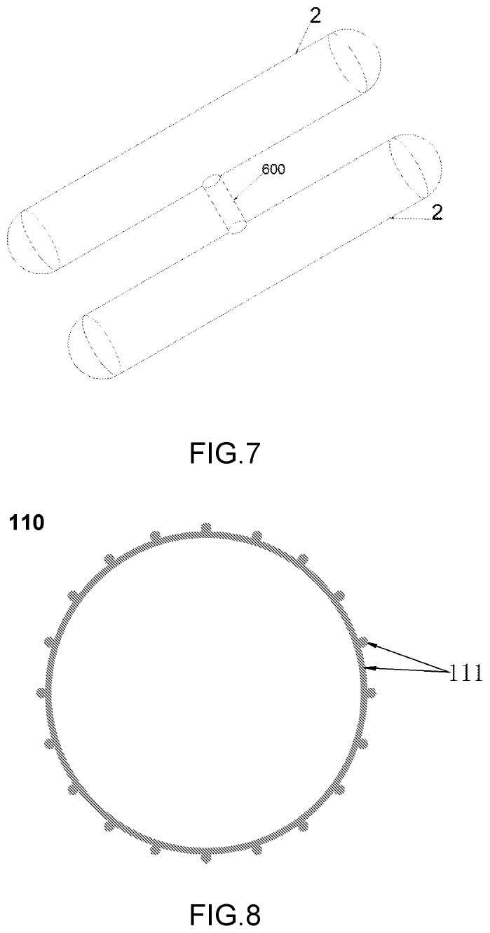

As shown in FIG. 7, this example provides a sealed underground energy storage chamber system, comprising at least two sealed underground energy storage chambers of Example 1. Said at least two sealed underground energy storage chambers are arranged parallel to each other and are mutually spaced apart from each other along radial directions of cross sections of said at least two sealed underground energy storage chambers. A connecting member 600 is provided between every two adjacent sealed underground energy storage chambers for reliable connection. In a preferred embodiment, in order to improve airtightness, a connecting area between the connecting member 600 and each of the two adjacent sealed underground energy storage chambers is provided with a second flange, and a sealing ring is provided on the second flange. In a specific implementation, in order to fully utilize the gas storage space while ensuring the safety of the sealed underground energy storage chambers, a distance between every two adjacent sealed underground energy storage chambers is 50-80 m.

### Example 3

This example provides a specific implementation of the sealed underground energy storage chamber of Example 1. With reference to FIGS. 1-6, the sealed underground energy storage chamber body 2 is a cylinder with an inner diameter of 8 m and a length of 80 m, and is arranged within the underground rock 1. The sealed underground energy storage chamber is surrounded by the compound concrete sealing layer 10 and the sealing liner layer 300. The sealing liner layer 300 is arranged on the inner surface of the compound concrete sealing layer 10, and is anchored and connected to the compound concrete sealing layer 10 by the V-shaped anchoring members.

Each of the anchoring members embodied as a rod and being inserted into a surface of the underground rock 1 has a diameter of 20 mm and a length of 920 mm. A length of the portion of each of the anchoring members inserted into the underground rock 1 is 600 mm, and the anchoring members are spaced apart from one another by an interval of 1000 mm, such that the bonding force between the compound concrete sealing layer 10 and the underground rock 1 can be improved.

The compound concrete sealing layer 10 comprises the self-stressing sprayed concrete layer 100 and the casted ultra-high-performance concrete layer 200 sequentially arranged along a radial direction from a perimeter of the sealed underground energy storage chamber body 2 towards a central axis of the sealed underground energy storage chamber body 2. The sealing liner layer 300 is arranged on the inner surface of the casted ultra-high-performance concrete layer 200. The first steel reinforcing mesh layer 110 is arranged inside the self-stressed concrete layer 100, and the second steel reinforcing mesh layer 210 is arranged inside the casted ultra-high-performance concrete layer 200. The volume of steel reinforcement bars used in the first steel reinforcing mesh layer 110 and the second steel reinforcing mesh layer 210 is not less than 1.5% of the volume of the concrete layers 100 and 200. Self-stressing of the self-stressing sprayed concrete layer 100 is not less than 1 MPa, a compressive strength of the self-stressing sprayed concrete layer 100 is not less than 40 MPa, and a thickness of the self-stressing sprayed concrete layer 100 is 200 mm. Each side length of each square grid unit 112 of the first grid of the first steel reinforcing mesh layer 110 is 100 mm. The diameter of each of the first steel reinforcement bars 111 is 8 mm. The first steel reinforcing mesh layer 110 is fixed on the anchoring members. The thickness of the protective layer 120 of the first steel reinforcing mesh layer 110 is 30 mm. The casted ultra-high-performance concrete layer 200 has the compressive strength greater than 150 MPa, the gas permeability of 1×10⁻¹⁸ m², the initial cracking strain greater than 1000με, and the thickness of 40 mm. Each side length of each square grid unit 212 of the second grid of the second steel reinforcing mesh layer 210 is 100-300 mm. The diameter of each of the second steel reinforcement bars 211 is 4 mm. The second steel reinforcing mesh layer 210 is fixed on the anchoring members. The thickness of the protective layer 220 of the second steel reinforcing mesh layer 210 is 25 mm. The casted ultra-high-performance concrete layer 200 can significantly reduce the thickness of the compound concrete sealing layer 10, and can prevent the gas from leakage and the sealed underground energy storage chamber from damage in case of failure of the sealing liner layer 300 or accidental overpressure.

The sealing liner layer 300 of the sealed underground energy storage chamber prevents the loosening and falling of rocks and solves the stability problem of the underground rock 1 surrounding the sealed underground energy storage chamber. It also solves the problem of gas leakage through the gaps of the underground rock 1 and prevents entry of excessive underground water into the sealed underground energy storage chamber.

The sealed underground energy storage chamber has a pressure resistance of 10-15 MPa, and a thermal resistance of −30 to 80° C. The sealing liner layer 300 is composed of high-density polyethylene with a thickness of 4 mm, a thermal resistant range from −50 to 90° C., a yield strength of not less than 30 MPa, a maximum tensile strength of not less than 50 MPa, a shearing resistance achieved via the V-shaped anchoring members between the sealing liner layer 300 and the inner surface of the compound concrete sealing layer 10 being not less than 20 Mpa; a bonding strength of anchoring cross-sections of the V-shaped anchoring members is not less than 10 Mpa, and an anchoring depth of each of the V-shaped anchoring members into the compound concrete sealing layer 10 is not less than 20 mm, leading to improved liner sealing performance and gas leakage prevention performance.

### Comparative Example 1

This comparative example adopts a sealed underground energy storage chamber manufactured from conventional concrete, and this example is identical with Example 3 except that a concrete liner layer used in lieu of the compound concrete compound concrete sealing layer of the present invention is formed by C40 concrete applied through spraying with a thickness of 300 mm and C40 steel fiber-reinforced concrete applied through casting with a thickness of 200 mm, and a steel plate with a thickness of 20 mm is used in lieu of the sealing liner layer disclosed in the present invention.

### Testing

Comparisons of some main features between Example 3 and Comparative Example 1 is shown in the following table:

| | Example 3 | | Comparative Example 1 | |
|---|---|---|---|---|
| Sprayed concrete | C40 sprayed concrete | | C40 sprayed concrete | |
| | of 200 mm thickness | | of 300 mm thickness | |
| | (compressive strength | | (compressive strength | |
| | not less than 40 MPa) | | not less than 40 MPa) | |
| Casted concrete | C150 ultra-high- | | C40 steel fiber- | |
| | performance concrete of | | reinforced concrete | |
| | 40 mm thickness | | of 200 mm thickness | |
| | (compressive strength | | (compressive strength | |
| | not less than 150 MPa) | | not less than 40 MPa) | |
| Inner diameter of | 8 | m | 8 | m |
| chamber | | | | |
| Excavation | 8.48 | m | 9 | m |
| diameter of | | | | |
| underground rock | | | | |
| for placement of the | | | | |
| chamber | | | | |
| Excavation volume | 4497 | m³ | 5089 | m³ |
| of underground rock | | | | |
| for placement of the | | | | |
| chamber | | | | |
| Thickness of | 240 | mm | 500 | mm |
| concrete liner layer | | | | |
| (of comparative | | | | |
| example 1)/ | | | | |
| compound concrete | | | | |
| sealing layer (of | | | | |
| example 3) | | | | |
| Weight of concrete | 1141769 | kg | 2563530 | kg |
| liner layer(of | | | | |
| comparative | | | | |
| example 1)/ | | | | |
| compound concrete | | | | |
| sealing layer (of | | | | |
| example 3) | | | | |

As can be seen from the data in the above table, with the same inner space of the chamber, the sealed underground energy storage chamber of Example 3, as compared with the sealed underground energy storage chamber manufactured from conventional concrete in Comparative Example 1, is lighter in structure, thinner in thickness of the compound concrete sealing layer as compared to the concrete liner layer of comparative example 1, shorter in excavation diameter, and smaller in excavation volume, and requires no steel plate as the sealing layer.

In Example 3, the ultra-high-performance concrete and the high-density polyethylene are adopted in lieu of the steel plate for manufacturing the chamber of the present invention, thereby reducing construction difficulty and manufacturing cost of the compound sealing layer of the present invention, reducing thickness of the compound concrete sealing layer, reducing material consumption, and improving fatigue resistance and creep resistance of the compound concrete sealing layer. Additionally, since the gas permeability of the ultra-high-performance concrete is much less than that of the common concrete, the ultra-high-performance concrete layers can also provide sealing performance.

Apparently, the above examples are only examples intended for illustrating the examples of the present invention, and are not intended to limit the specific implementation of the present invention. Any modification, equivalent configuration, improvement, and the like made without departing from the spirit and essence of the claims of the present invention shall fall within the protection scope of the claims of the present invention.

What is claimed is:

1. A sealed underground energy storage chamber, comprising a sealed underground energy storage chamber body; wherein the sealed underground energy storage chamber body has a compound sealing layer; the compound sealing layer comprises, sequentially along a radial direction from a perimeter of the sealed underground energy storage chamber body towards a central axis of the sealed underground energy storage chamber body, a compound concrete sealing layer and a sealing liner layer; the compound concrete sealing layer at least comprises one casted ultra-high-performance concrete layer; the sealing liner layer is attached to an inner surface of the casted ultra-high-performance concrete layer; a thickness of the casted ultra-high-performance concrete layer is 40-80 mm, a compressive strength of the casted ultra-high-performance concrete layer is greater than 150 Mpa, a gas permeability of the casted ultra-high-performance concrete layer is 1×10⁻¹⁸ m² to 5×10⁻¹⁹ m², and an initial cracking strain of the casted ultra-high-performance concrete layer is greater than 1000με.

2. The sealed underground energy storage chamber of claim 1, wherein a plurality of first fasteners are provided in the compound concrete sealing layer.

3. The sealed underground energy storage chamber of claim 2, wherein the first fasteners are anchoring members which are in rod shape; each of the anchoring members has a diameter of 20-30 mm, and/or each of the anchoring members has a length of 920-1520 mm, and/or the anchoring members are spaced apart from one another by an interval of 1000-2000 mm.

4. The sealed underground energy storage chamber of claim 2, wherein a plurality of second fasteners are provided between the sealing liner layer and the casted ultra-high-performance concrete layer.

5. The sealed underground energy storage chamber of claim 4, wherein the second fasteners are V-shaped anchoring members; the V-shaped anchoring members pass through the sealing liner layer and then being embedded into the casted ultra-high-performance concrete layer, such that the sealing liner layer is attached to the inner surface of the casted ultra-high-performance concrete layer.

6. The sealed underground energy storage chamber of claim 1, wherein the compound concrete sealing layer further comprises a self-stressing sprayed concrete layer; the self-stressing sprayed concrete layer and the casted ultra-high-performance concrete layer are sequentially laminated layers laminated along the radial direction from the perimeter of the sealed underground energy storage chamber body towards the central axis of the sealed underground energy storage chamber body.

7. The sealed underground energy storage chamber of claim 6, wherein a thickness of the self-stressing sprayed concrete layer is 80-400 mm, and/or self-stressing of the self-stressing sprayed concrete layer is not less than 1 Mpa, and/or a compressive strength of the self-stressing sprayed concrete layer is not less than 40 Mpa.

8. The sealed underground energy storage chamber of claim 6, wherein the self-stressing sprayed concrete layer is formed as an ultra-high-performance self-stressing sprayed concrete layer.

9. The sealed underground energy storage chamber of claim 8, wherein a thickness of the ultra-high-performance self-stressing sprayed concrete layer is 80-120 mm.

10. The sealed underground energy storage chamber of claim 6, wherein a first steel reinforcing mesh layer is provided inside the self-stressing sprayed concrete layer; a volume of the first steel reinforcing mesh layer being used is not less than 1.5% of a volume of the self-stressing sprayed concrete layer, and/or the first steel reinforcing mesh layer comprises a plurality of first steel reinforcement bars where a diameter of each of the first steel reinforcement bars is 8-12 mm, and/or the first steel reinforcing mesh layer is formed as a first grid where each side length of each grid unit of the first grid is 100-300 mm; and/or a thickness of a protective layer of the first steel reinforcing mesh layer is 30-50 mm, wherein the protective layer of the first steel reinforcing mesh layer is a portion of the self-stressing sprayed concrete layer extending from the first steel reinforcing mesh layer to an outer side surface of the self-stressing sprayed concrete layer.

11. The sealed underground energy storage chamber of claim 10, wherein a second steel reinforcing mesh layer is provided inside the casted ultra-high-performance concrete layer; a volume of the second steel reinforcing mesh layer being used is not less than 1.5% of a volume of the casted ultra-high-performance concrete layer, and/or the second steel reinforcing mesh layer comprises a plurality of second steel reinforcement bars whereas a diameter of each of the second steel reinforcement bars is 4-10 mm, and/or the second steel reinforcing mesh layer is formed as a second grid where each side length of each grid unit of the second grid is 100-300 mm, and/or a thickness of a protective layer of the second steel reinforcing mesh layer is 25-40 mm, wherein the protective layer of the second steel reinforcing mesh layer is a portion of the casted ultra-high-performance concrete layer extending from the second steel reinforcing mesh layer to an outer side surface of the casted ultra-high-performance concrete layer.

12. The sealed underground energy storage chamber of claim 1, wherein the sealing liner layer is formed as a high-density polyethylene layer.

13. The sealed underground energy storage chamber of claim 12, wherein a thickness of the high-density polyethylene layer is 4-6 mm, and/or a yield strength of the high-density polyethylene layer is not less than 30 Mpa, and/or a maximum tensile strength of the high-density polyethylene layer is not less than 50 Mpa, and/or a thermal resistance range of the high-density polyethylene layer is from −50° C. to 90° C.

14. The sealed underground energy storage chamber of claim 1, wherein the sealed underground energy storage chamber body comprises a hollow cylindrical portion and a hemispherical end portion at each of two ends of the hollow cylindrical portion; the hollow cylindrical portion and each hemispherical end portion are provided with the compound sealing layer.

15. A sealed underground energy storage chamber system, comprising at least two sealed underground energy storage chambers each being defined in claim 1; said at least two sealed underground energy storage chambers are arranged parallel to each other and are mutually spaced apart from each other along radial directions of cross sections of said at least two sealed underground energy storage chambers; a connecting member is provided between sealed underground energy storage chamber bodies of every two adjacent sealed underground energy storage chambers to connect the two adjacent sealed underground energy storage chambers.
